(19) United States
(12) Patent Application Publication
(10) Pub. No.: US 2008/0228524 A1
(43) Pub. Date: Sep. 18, 2008

(54) Method of manipulating health related documents

(76) Inventor: Geraldine Brown, Dallas, TX (US)

Correspondence Address: Robert M. Mason;Mason & Petruzzi, 13601 Preston Rd., 402W, Dallas, TX, 75240, US

(21) Appl. No.: 11/717,537

(22) Filed: Mar. 13, 2007

(51) Int. Cl. G06F 19/00

(52) U.S. Cl. 705/3

(57) ABSTRACT

A method is disclosed for submitting, collecting, storing and retrieving (1) advanced directives such as living wills, medical proxies, (2) medical and pharmaceutical records, and (3) wills and estate documents, all within a secure environment. Once individual consumers have registered and provided appropriate identifying information for use in retrieving stored documents later, they enter a secure area of the website and may use the forms of advanced directives and testamentary documents provided there, may choose to follow displayed hypertext links that lead to forms mandated by the jurisdiction where they are resident (if available), or may choose to submit their own forms prepared in coordination with their personal legal, healthcare and tax advisors. The documents are stored in electronic format in a remote location and may only be retrieved online at a later date by an individual or a healthcare provider possessing the credentials required to access the online vault.

### BACKGROUND OF THE INVENTION

1. Field of the Invention

The invention relates to all forms of advanced directives, medical records and testamentary documents. In particular, the invention pertains to a process of securely registering with an online service, choosing and submitting documents for storage in the online vault, then subsequently accessing the online vault and retrieving the documents stored there if and when needed.

2. Description of Related Art

Advanced directives, such as living wills and medical proxies, allow individuals to make decisions about how they wish to be medically treated (or not) in the event that they later become incapacitated and unable to express those wishes personally to healthcare providers. Advanced directives come in many forms depending on requirements of a given jurisdiction, but they typically either (a) direct healthcare providers to utilize various procedures including, for example, artificial resuscitation and breathing machines, feeding tubes, and so on, in order to treat them, or, alternatively, they direct healthcare providers not to use such procedures; or (b) appoint a proxy to make decisions on the individual's behalf regarding the extent to which healthcare providers should, or should not, use various measures to treat the patient and save his life. Although advanced directives can be extremely useful to individuals who desire to have a choice in their medical treatment in times of emergency, such directives are only useful to the extent that they are prepared and can be located and provided to healthcare providers when and if necessary.

Medical records are those records that are prepared and stored in various locations, and by a multitude of healthcare professionals and institutions, relating to medical care given to an individual from birth, throughout all phases of life, and leading up to death. Such records can include birth certificates and vital statistics, records relating to various illnesses suffered by, and treatments provided to, the individual, records on surgeries and other medical interventions, dental records, and even pharmaceutical records. Depending on the evolution of an individual's life, he may spend periods of time in many different geographic locations and jurisdictions, thus resulting in such medical records being distributed and stored literally across the globe. Once again, medical records are only helpful to individuals to the extent that an individual's healthcare providers can locate them when the need arises.

Finally, testamentary documents include instruments such as wills, testaments, and documents appointing legal guardians for minor children and medical dependents. All too often, these documents cannot be found when an individual dies, and the family of the deceased and the authorities of the jurisdiction where the deceased person's property is located are left to fight over the disposition of that property.

Traditionally, most individuals have not considered the benefits of preparing and storing advanced directives. In common law jurisdictions such as the United States and the United Kingdom, it is more common for individuals to prepare testamentary instruments such as wills, while in civil law jurisdictions such as France, matters of succession are primarily addressed by statute. In instances where individuals have actually prepared advanced directives and/or testamentary instruments, they have traditionally stored them in their homes, with legal advisors, or with their healthcare providers. As mentioned above, in an age where geographical mobility has become the norm rather than the exception, it is very common for individuals to have hard copies of medical and dental records stored in the offices or off-site storage facilities of healthcare providers spread across a continent, or even throughout the world. In recent history, various methods have been proposed to facilitate the storage and retrieval of advanced directives, medical records and testamentary instruments. While certain methods propose the storage of such records on “movable media” such as flash memory drives, other methods propose the creation of central depositories for advanced directives or medical records, with such records being retrievable by means of a telephone or computer query system.

Prior art, however, has failed to address two fundamental questions: (1) How can individuals be encouraged to make a responsible decision to register with an online service and submit advanced directives, medical records and testamentary documents for storage with that online service? and (2) How can healthcare providers and legal professionals be educated and conditioned to automatically access that online vault to search for and retrieve the documents stored there if and when needed?

### BRIEF SUMMARY OF THE INVENTION

The present invention is directed to a method to (1) encourage individuals to be proactive in the creation and online storage of advanced directives, medical records and testamentary instruments in a safe and secure “online vault” (and for rewarding them for doing so), and (2) educate and condition healthcare providers, government officials and legal professionals to securely access the online vault from anywhere in the world where there is access to the Internet in order to retrieve documents stored there if and when needed.

As suggested above, one embodiment of the invention consists of two complimentary services, one for individuals interested in learning more about advanced directives and/or testamentary documents, as well as registering and providing for the online storage of such documents and medical records, and another service for healthcare providers, government authorities and legal professionals with a need to access and retrieve any such documents. The point of departure for both individuals and providers, authorities or professionals is the same. Potential users of the services are directed to an online website by any number of marketing strategies. Upon arriving at the website, users are directed to choose the geographic jurisdiction in which they are located or interested. Based on their decision, users are directed to mirror sites containing content in the language of the jurisdiction chosen, e.g., English, French, Spanish, Chinese, etc. Once the jurisdiction has been established, individual users are given the opportunity to access non-secure areas of the site containing general information on advanced directives and testamentary instruments, and on legal requirements for the preparation, enforcement and application, as well as the storage and retrieval, of such documents in their jurisdiction. In one embodiment of the invention, individuals become eligible to receive discounts on merchandise or services, or other rewards, from certain sponsors when they register for the services and submit advanced directives, medical records or testamentary instruments for storage in the online vault. Accordingly, the non-secure portion of the website contains information on the rewards offered by sponsors. Just as importantly, individuals are informed of the security measures implemented to ensure that any information provided or documents submitted will be done so in an absolutely secure environment. One embodiment of the invention provides for the use of multi-value logic, as opposed to binary, encryption technology combined with secured chips or “smart” cards to ensure that the information and documents stored in the online vault may only be accessed by authorized persons. U.S. Pat. No. 6,133,754 to E. D. Olsom entitled Multiple-Valued Logic Circuit Architecture; Supplementary Symmetrical Logic Circuit Structure (SUS-LOC) is incorporated by reference as if set forth entirely herein.

Individuals are also given the opportunity to register with the service. If they choose to register, then they are prompted to provide as much identifying information about themselves as possible, including official records such as social security or other identification numbers, legal information such as date of birth, marital status and identifying information on next-of-kin, physical attributes such as height, weight, eye and hair color, and other distinguishing characteristics, and even biometrics such as fingerprints, DNA or genetic profile, and/or dental records. The individual may also upload several photographs to his profile to assist with physical identification. Finally, the individual is prompted to provide emergency contact information for identification and tracking purposes. Upon completion of the registration process, individuals are provided directions on how to submit documents for storage in the online vault. In certain jurisdictions, individuals are given the choice of (1) using form documents provided or officially approved by government authorities in the jurisdiction, (2) using form documents and instruments provided by the service providers, or (3) submitting for storage the documents and instruments that they have prepared in consultation with their personal healthcare providers and/or legal and tax advisors, as appropriate. The individual is solely responsible for the correct and complete preparation, execution, notarization, and submission of the advanced directives, medical records or testamentary instruments, as applicable. Although the service provider may choose to return documents to the individual upon the discovery of blatant or apparent errors in their preparation, completion or execution, it is not contemplated that it is the service provider's responsibility to do so. The individual may submit the documents to the service provider in hard copy or in electronic format by courier or registered mail service, by facsimile transmission, or by electronic transmission such as electronic mail or dedicated transmission lines. The service provider is responsible for the secure storage and retrieval of the documents submitted. In one embodiment of the invention, the service provider can also store hard copy originals in a secured storage facility for provision in jurisdictions that require such originals to be enforced.

Upon completion of registration and the submission by the individual of documents for storage in the online vault, the service provider prepares and sends to the individual acknowledgement of the receipt of the documents (with a precise description of same) and a card that contains a magnetic strip or a miniature chip encoded with identifying information on the individual, which information is protected by encryption technology. In one embodiment of the invention, such information is incorporated into an insurance card, a driver's license or some other official identification card provided to and carried by the individual. In the illustrated embodiment, the card does not contain electronic information relating to the documents being stored, nor does it contain an electronic version of those documents. Rather, the information on the card acts as a “key” to the online vault that allows healthcare providers, government authorities and legal professionals equipped with the appropriate readers to “unlock” the online vault and access and retrieve the individual's advanced directives, medical records and testamentary documents stored there. In the embodiment of the invention in which the individual receives rewards from sponsors for joining the site and submitting documents for storage, the service provider also provides to the individual a “rewards card” that may be shown to sponsors to receive discounts on purchases of merchandise and services.

The service provider instructs the individual registered with the service to carry the card provided to him at all times to ensure that such individual's advanced directives, medical records and/or testamentary instruments can be quickly and efficiently located, accessed and retrieved in the event of an emergency. However, it is not critical that the individual have the card with him in order for properly equipped and authorized healthcare providers, government authorities and/or legal professionals to locate, access and retrieve the individuals documents stored in the online vault, as will be discussed further below.

Once the individual has registered with the service provider and submitted his medical records for storage in the online vault, then any healthcare provider located anywhere in the world that (1) has access to the Internet and (2) possesses the required card reader can go to the online vault website, swipe the healthcare provider's card (if a magnetic strip) or insert the card into the “smart card” reader (if a “smart card” chip), then do the same thing with the individual's card, and pull up the individual's medical records 24 hours a day, 7 days a week. Similarly, if the individual is conscious at the time that he is admitted to a healthcare facility, then as long as the healthcare facility in question has access to the Internet and the required card reader, authorized healthcare professionals will be able to unlock the vault and access and retrieve the person's medical records, advanced directives and testamentary instruments.

Unfortunately, in some instances, an individual will be incapacitated at the time he is transported and admitted to a healthcare facility. These are the cases that pose the most serious challenges to prior methods of storing advanced directives, medical records and/or testamentary instruments. Maybe the incapacitated person will have family accompanying him who can provide doctors with information on the person's primary physician, his insurance provider and, in the best of cases, the location of the individual's advanced directives, medical records and testamentary instruments. If the incapacitation occurs in a foreign jurisdiction, however, it may be impossible for healthcare providers to actually locate and access those vital documents or the persons in charge of their storage. Moreover, healthcare providers in the individual's jurisdiction of residence may be very hesitant to transmit the contents of those documents to a foreign jurisdiction. Finally, in a worst-case scenario, the incapacitated person may be traveling alone and have no one capable of providing the necessary information to caregivers.

It is in these cases that the present invention is the most advantageous to all of the interested parties. Returning to the original description of the Internet website, healthcare providers, government authorities and legal professionals that visit the site and choose their appropriate jurisdiction are prompted to provide their authorizing credentials to access the secure portion of the website. The only way for such providers, authorities or professionals to log into the secured portion of the site is to introduce a “key card” provided to them by the service provider into the specialized card reader and input an assigned user name and password that allows the service provider to track exactly who is accessing the online vault. Once the healthcare provider, governmental authority or legal professional has introduced its key card into the reader and logged onto the secure portion of the site, it can search for a positive match using the identifying information for the individual available. Using this system protects the individual's information by limiting access only to authorized parties that possess both a key card and a card reader issued by the service provider. Furthermore, it protects the healthcare providers, authorities and legal professionals by providing them a maximum amount of information that significantly decreases the likelihood of a false positive match.

Once the authorized healthcare provider, government official or legal professional has located and retrieved the necessary advanced directives, medical records or testamentary instruments from the online vault, they can print the documents and, in one embodiment of the invention, they can contact the service provider to request the originals if necessary to enforce those documents in the jurisdiction in question.

The current invention contemplates several methods of ensuring that the information and documents stored in the online vault are updated on a regular basis, beginning with the individual's registration. Upon completion of the registration process, the individual is given a fixed amount of time to submit his advanced directives, medical records and/or testamentary documents for storage in the online vault. If the individual fails to do so, then the service provider is prompted to send a communication by regular mail and/or electronic mail reminding the individual of the registration and requesting that the person submit such documents. Furthermore, the system parameters can be set to send similar communications to individuals on a pre-determined basis, e.g., triggered by passage of time, change of address, etc., reminding them to update any personal information and/or documents stored as necessary or desired.

By educating individuals about the merits of advanced directives and testamentary instruments, by encouraging them to make the responsible decision to prepare such documents, by convincing them to submit those documents and their medical records for storage in an online vault (and rewarding them for doing so), and by providing them with a secure means to do so, the present method significantly increases the number of advanced directives, medical records and testamentary instruments that will be stored in a secure, centralized depository. Furthermore, by recruiting healthcare professionals, government authorities and legal professionals throughout the world to participate in the system, the present method increases the likelihood that individuals' advanced directives, medical records and testamentary instruments will be quickly and efficiently located, accessed and retrieved in a secure matter whenever and wherever such documents are needed.

Other objects and advantages will become apparent from the following descriptions, taken in connection with the accompanying drawings, wherein, by way of illustration and example, an embodiment of the present invention is disclosed.

### BRIEF DESCRIPTION OF THE SEVERAL DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

The various features, objects and advantages of this invention as summarized above, and the manner in which they operate and work together to the benefit of individuals, their family members, healthcare providers, insurance companies and government officials can be better understood and appreciated by referencing the description of an embodiment of the invention set forth below taken in conjunction with the following illustrations:

FIG. 1 is a schematic illustration of the method of registering with the service and submitting documents for storage in the online vault in accordance with a preferred embodiment of the present invention.

FIG. 2 is a schematic illustration of the method of retrieval of documents stored in the online vault in accordance with a preferred embodiment of the present invention.

FIG. 3 is a schematic illustration of the flow of information in accordance with a preferred embodiment of the present invention.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific detail, location, or composition. Therefore, specific details disclosed herein are not to be interpreted as limiting, but rather as a basis for the claims and as a representative basis for teaching one skilled in the art to employ the present invention in virtually any appropriately detailed system, structure or manner.

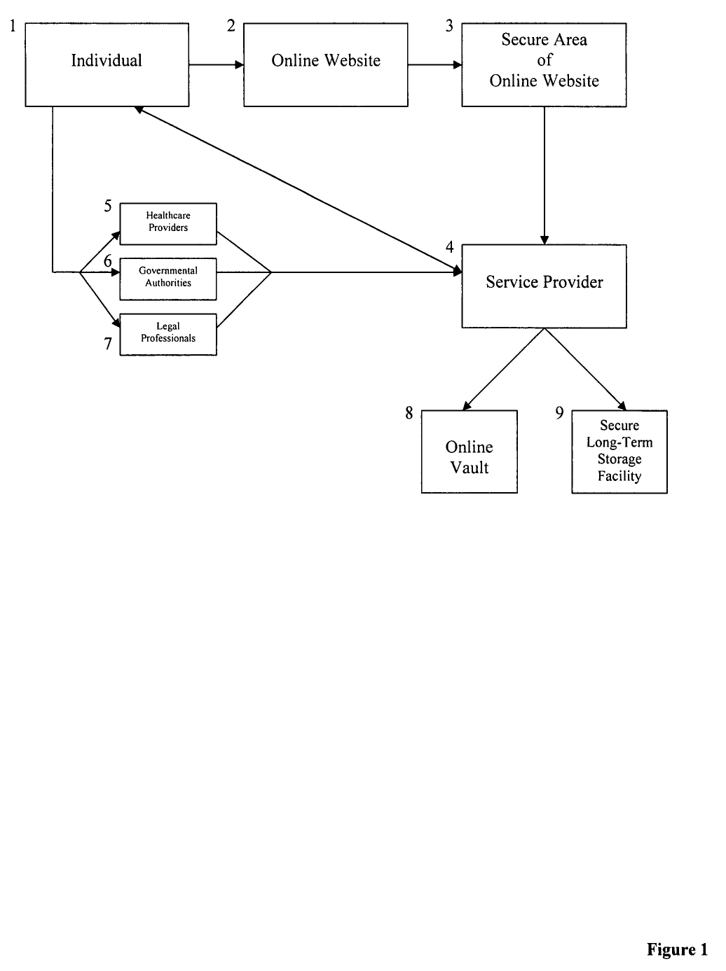

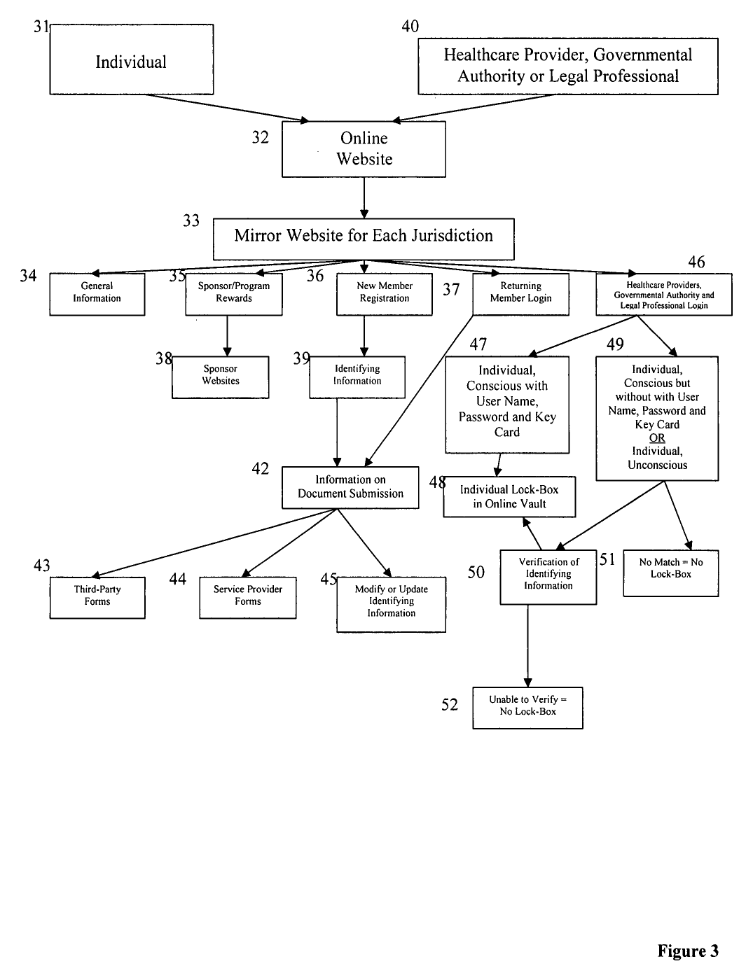

With reference to FIGS. 1 and 3, an individual 1, 31 goes to an online website 2, 32 where he is prompted to choose the jurisdiction in which he is resident. If the individual chooses the United States, then he is subsequently prompted to choose the state in which he is resident; however, if he chooses a jurisdiction outside of the United States, then he is sent to a mirror website created for and in the language of the chosen jurisdiction 33. Once at the website 2, 32, the individual is given the choice to access general information on the preparation, use and storage of advanced directives, medical records and testamentary instruments; obtain information on sponsors of the rewards program 35 developed by the service provider 4, as well as hypertext links to the sponsors' websites 38; or access a secure area of the website 3 where the individual can either register as a new member of the service 36 or log in as an existing member of the service 37. It is contemplated that existing members would only be permitted to log in and access the secure area 3 if they have proper identification credentials, e.g., a user name, password and security code assigned by the service provider 4 and sent to the individual 1, 31.

If the individual 1, 31 decides to subscribe to the service, then he is prompted to provide to the service provider 4 as much identifying information as possible, e.g., legal information such as driver's license, social security or other identification numbers, date of birth, marital and parental status, nationality and passport information, and contact information for next-of-kin; physical information such as height, weight, hair and eye color, blood type, and other identifying characteristics; and biometric information such as fingerprints and even genetic mapping information. In the event that the individual 1, 31 later submits advanced directives, medical records or testamentary instruments to the service provider 4 for storage or requests that healthcare providers 5, 40, government authorities 6, 40 or legal professionals 7, 40 to do so, then the information provided by the individual 1, 31 can be cross-tagged with the information provided by such third parties 40 to decrease the likelihood of false positives when healthcare providers 5, 40, government authorities 6, 40 or legal professionals 7, 40 subsequently conduct searches for the individual's documents stored in the online vault 8.

Once an individual 1, 31 has either registered as a new member 39 or logged in as a returning member 37, he is directed to a web page 42 that contains general information relating to methods the individual 1, 31 may use to submit documents to the service provider 4 for storage in the online vault 8 or request that healthcare providers 5, 40, government authorities 6, 40 or legal professionals 7, 40 do so. From that web page 42, the individual can also access online forms of advanced directives, medical record release and transfer forms, and testamentary instruments prepared by the service provider 44 or click on hypertext links leading to external government-authority sponsored web sites with forms mandated by the jurisdiction in question 43. Returning members that have logged into the secure area 3 would also be permitted to modify or update their identifying information. Such updates would prompt the service provider 4 to send reminders to the individual 1, 31 to complete, execute and submit new forms of advanced directives, medical records and testamentary instruments if necessary due to a change in the individual's jurisdiction of residence.

Upon completion of an individual's new member registration 36 and provision of identifying information 39, the service provider 4 sends to the individual 1, 31 a registration acknowledgement, a user name and password and, if necessary, a reminder to submit advanced directives, medical records and/or testamentary instruments for storage in the online vault, or to request that healthcare providers 5, 40, government authorities 6, 40 or legal professionals 7, 40 do so.

The individual 1, 31 sends advanced directives and testamentary instruments to the service provider 4 for storage in the online vault 8. The individual also instructs healthcare providers 5, 40, e.g., physicians, dentists and pharmacies and legal professionals 7, 40 to submit medical records, dental records, information on prescriptions and medical allergies, and testamentary instruments to the service provider 4 for storage in the online vault 8. Depending on the requirements of the jurisdiction, the individual 1, 31 may send such documents by overnight courier, registered mail, facsimile transmission, or by electronic mail.

Once the service provider 4 has received the advanced directives, medical records and/or testamentary instruments from the individual 1, 31, or from the healthcare providers 5, 40, government authorities 6, 40 or legal professionals 7, 40, as appropriate, the service provider 4 may scan the documents for completeness and proper execution, and it may return incomplete or improperly prepared or executed documents to the individual 1, 31 for corrections; however, the service provider 4 is not required to do so. Assuming that the documents in question appear to have been properly prepared and executed, the service provider 4 does each of the following: (a) the service provider 4 prepares electronic versions of the documents submitted and uploads them into storage on secure servers accessible by Internet, i.e., the online vault 8; (b) depending on the instructions received by the individual 1, 31 and the legal requirements of the jurisdiction where the individual 1, 31 is resident, the service provider 4 either returns any original documents received by courier service or registered mail to the individual 1, 31 or stores them in a secure, offsite, long-term storage location 9 for later retrieval 46, 47 by healthcare providers 5, 40, government authorities 6, 40 or legal professionals 7, 40, as appropriate; (c) sends a small card with either “smart card” chip technology, a magnetic strip or other storage material, any of which is embedded with encryption technology incorporating multi-value logic or an equivalent security technology, to the individual 1, 31; and (d) sends a “program rewards card” to the individual 1, 31 that he can use to receive discounts on merchandise or services from program sponsors. With respect to (c) above, the service provider 4 could also coordinate with third-party medical expense payers, e.g., insurance companies and/or government authorities, depending on the jurisdiction in question to ensure that the “smart card” chip or the magnetic strip, protected with multi-value logic or other security technology, is incorporated into an individual's insurance card or other medical benefits identification card. This card subsequently serves as the “key” to unlock the individual's “lock-box” in the online vault.

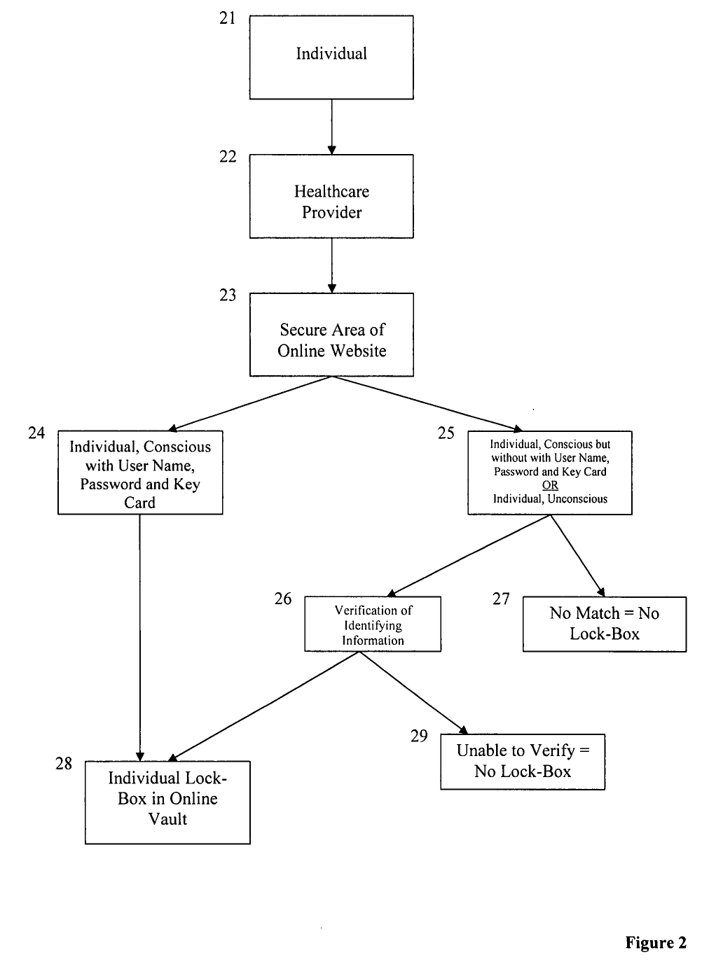

In addition to the description of an individual's subscription to the online vault service, FIGS. 2 and 3 further illustrate how a healthcare provider 22, 40, governmental authority 40 or a legal professional can access the online website 32 and the individual's “lock-box” in the online vault 28, 48 for the purposes of either uploading or retrieving, viewing and printing advanced directives, medical records or testamentary instruments.

A governmental authority or a legal professional 40 goes to the online website 32, where it chooses the jurisdiction in which it is located and is sent to the mirror website for that jurisdiction 33. The governmental authority or legal professional 40 is prompted to log into the secure area of the online website 23. To log into the secure area of the online website 23, the governmental authority or legal professional 40 must possess (a) a key card with either “smart card” chip technology or a magnetic strip, either of which is embedded with encryption technology incorporating multi-value logic or an equivalent security technology, (b) a key card reader, and (c) identifying credentials, e.g., additional user names and/or passwords, each of which is issued by the service provider 4 to the governmental authority or legal professional 40 when it joins the service. The governmental authority or legal professional 40 introduces its key card into the card reader and enters its identifying credentials, upon which it gains access to the secure area of the online website 23.

At this point, if the governmental authority or legal professional 40 desires to access the individual lock-box in the online vault 28, 48 of an individual 21, 31 that (a) is a member of the service, (b) has submitted documents for storage in the online vault 8 as described above, and (c) is conscious and has his user name, password and key card 47, then the governmental authority or legal professional 40 introduces the individual's key card into the card reader and enters the individual's user name and password, and the governmental authority or legal professional 40 gains access to the individual's lock-box in the online vault 28, 48, where the governmental authority or legal professional 40 can either upload electronic versions of the individual's advanced directives, medical records or testamentary instruments for storage in the online vault 8 or access, retrieve, view and print those documents.

Healthcare providers' 22, 40 access to an individual's lock-box in the online vault 28, 48 takes place in a similar manner. The invention contemplates that healthcare providers 28, 48 will primarily access an individual's lock-box in the online vault 28, 48 for two reasons, i.e., either to upload medical records or to access, retrieve, view and print advanced directives, medical records or, in certain situations, testamentary instruments, e.g., when an individual 21, 31 is deceased and the healthcare provider 22, 40 is in a position to transmit the individual's testamentary instruments to next-of-kin, executors or legal representatives. The process is essentially the same in either situation. The healthcare provider 22, 40 goes to the online website 32, where it chooses the jurisdiction in which it is located and is sent to the mirror website for that jurisdiction 33. The healthcare provider 22, 40 is prompted to log into the secure area of the online website 23. In order to log into the secure area of the online website 23, the healthcare provider 22, 40 must possess (a) a key card with either “smart card” chip technology or a magnetic strip, either of which is embedded with encryption technology incorporating multi-value logic or an equivalent security technology, (b) a key card reader, and (c) identifying credentials, e.g., additional user names and/or passwords, each of which is issued by the service provider 4 to the healthcare provider 22, 40 when it joins the service. The healthcare provider 22, 40 introduces its key card into the card reader and enters its identifying credentials, upon which it gains access to the secure area of the online website 23.

At this point, if the healthcare provider 22, 40 desires to access the individual lock-box in the online vault 28, 48 of an individual 21, 31 that (a) is a member of the service, (b) has submitted documents for storage in the online vault 8 as described above, and (c) is conscious and has his user name, password and key card 47, then the healthcare provider 22, 40 introduces the individual's key card into the card reader and enters the individual's user name and password, and the healthcare provider 22, 40 gains access to the individual's lock-box in the online vault 28, 48, where it can either upload electronic versions of the individual's medical records for storage in the online vault 8 or access, retrieve, view and print the individual's advanced directives, medical records or testamentary instruments.

In contrast to the preceding paragraph, if the healthcare provider 22, 40 desires to access the individual lock-box in the online vault 28, 48 of an individual 21, 31 that (a) is a member of the service, (b) has submitted documents for storage in the online vault 8 as described above, and (c) is conscious, but does not have his key card, user name and/or password, or is unconscious or otherwise incapacitated, then the healthcare provider 22, 40 is prompted to enter as much identifying, i.e., legal, physical and biometric, information related to the individual 21, 31 as possible. The healthcare provider 22, 40 can conduct a similar search with respect to an unconscious individual that does not possess any identification card at all. If the identifying information provided by the healthcare provider 22, 40 is sufficient in quantity and quality to ensure a very high degree of likelihood of a match with an individual 21, 31 registered with the system, the healthcare provider 22, 40 is informed that there is a preliminary match, in which case the healthcare provider 22, 40 is prompted to verify the identifying information of the individual 26, 51. If the identifying information provided by the healthcare provider 22, 40 is insufficient in either quantity or quality to ensure a very high degree of likelihood of a match with an individual, then the healthcare provider 22, 40 is informed that there is no match, thus no accessible lock-box 27, 51.

If the healthcare provider 22, 40 is able to positively verify the identifying information of an individual 21, 31, then the healthcare provider 22, 40 is granted access to the individual's lock-box in the online vault 28, 48, where it can either upload electronic versions of the individual's medical records for storage in the online vault 8 or access, retrieve, view and print the individual's advanced directives, medical records or testamentary instruments. If, however, the healthcare provider 22, 40 is unable to make a sufficiently positive verification of the identifying information, then it is not granted access to any lock-box in the online vault 29, 52.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method of manipulating health related documentation comprising the steps of:
registering one or more individuals;
each one or more individuals providing identifying information from the group of: official records, identifying numbers, legal information, physical attributes, distinguishing characteristics, photographs and biometrics;
each one or more individuals providing health related documentation from the group of: advanced directives, medical records and testamentary documents;
registering one or more authorized persons to access the one or more individuals health related documentation;
providing each one or more authorized persons access credentials required to access the health related documentation.
